(19) United States
(12) Patent Application Publication
(10) Pub. No.: US 2007/0049189 A1
(43) Pub. Date: Mar. 1, 2007

(54) VENTILATOR

(75) Inventors: Ho Beom LEE, Kimhae-si (KR); Kyung Hwan KIM, Euiwang-si (KR); Keun Hyoung CHOI, Seoul (KR); Dong Whan CHOI, Busan (KR); Ho Seon CHOI, Seoul (KR); Jong Hoon PARK, Changwon-si (KR); Chang Hyun SONG, Busan (KR)

Correspondence Address: GREENBLUM & BERNSTEIN, P.L.C., 1950 ROLAND CLARKE PLACE, RESTON, VA, 20191, US

(73) Assignee: LG ELECTRONICS INC., Seoul (KR)

(21) Appl. No.: 11/463,335

(22) Filed: Aug. 9, 2006

(30) Foreign Application Priority Data
Aug. 11, 2005 (KR) 2005-73911

(51) Int. Cl. E06B 7/02

(52) U.S. Cl. 454/223

(57) ABSTRACT

A ventilator is provided. The ventilator includes blowers 60 and 70; ducts 62 and 72 that are connected to the blowers 60 and 70 to form a blow path having at least one bent part; and a sound-absorbing material 90 that is provided in the bent part of the blow path of the ducts 62 and 72 to absorb noise within the blow path thereof. Therefore, it is possible to remarkably reduce or prevent flow noise that is propagated to the inside of a room as noise of a flow passing through the ducts 62 and 72 is absorbed by the sound-absorbing material 90.

This Nonprovisional application claims priority under 35 U.S.C. §119(a) on Patent Application No. 10-2005-0073911 filed in Korea on Aug. 11, 2005, the entire contents of which are hereby incorporated by reference.

### BACKGROUND OF THE INVENTION

1. Field of the Invention

The present invention relates to a ventilator, and more particularly, to a ventilator with a sound-absorbing material that can absorb flow noise within a duct that guides blowing power of a blower.

2. Description of the Background Art

In general, a ventilator is an apparatus for exhausting contaminated indoor air to the outside of a room and for sucking fresh outdoor air to the inside of the room while maintaining a room temperature.

As disclosed in Japanese Patent Application Laid-open No. 1999-287492 (Oct. 12, 1999), a conventional ventilator exhausts contaminated indoor air to the outside of a room via an exhaust blower and a heat exchanger with blowing power of the exhaust blower by driving the exhaust blower and sucks fresh outdoor air to the inside of the room via a suction blower and the heat exchanger with blowing power of the suction blower by driving the suction blower.

The heat exchanger exchanges latent heat thereof due to the difference in a temperature and humidity between gas that is exhausted from the inside to the outside of the room and air that is sucked from the outside to the inside of the room using a material that can permeate vapor in an atmosphere.

However, as described above, in the conventional ventilator, there is a problem in that flow noise is generated due to flow resistance in a duct that guides the flow of suction air or exhaust gas and the flow noise is propagated to the inside of the room through the duct.

### SUMMARY OF THE INVENTION

Accordingly, an object of the present invention is to solve at least the problems and disadvantages of the background art.

An object of the present invention is to provide a ventilator that can minimize flow noise that propagates to the inside of a room through the duct by providing a sound-absorbing material that can absorb flow noise in a bent part of the duct when at least one bent part is formed at one side of the inside of a duct that guides the flow of suction air and exhaust gas.

According to an aspect of the present invention, there is provided a ventilator including: a blower; a duct that is connected to the blower to form a blow path having at least one bent part; and a sound-absorbing material that is provided in the bent part of the blow path of the duct to absorb noise within the blow path thereof.

The blower may include an exhaust blower for exhausting indoor air to the outside of the room and a suction blower for sucking outdoor air to the inside of the room.

The blower may include an exhaust blower for exhausting indoor air to the outside of a room and a suction blower for sucking outdoor air to the inside of the room; and a sound-absorbing material may be provided in at least a duct that forms a blow path of the suction blower.

The duct may be made of expandable polystyrene (EPS).

In the duct, the blow path thereof may have at least one bent part that is bent with a right angle.

In the sound-absorbing material, at least a portion corresponding to a corner of a bent part of the blow path of the duct may be formed in a curve shape.

The sound-absorbing material may be provided to form a cavity (empty space) between the duct and the sound-absorbing material.

The sound-absorbing material may be supported by at least one rib that is protruded from the duct.

The sound-absorbing material may be provided to form a cavity between the duct and the sound-absorbing material and at least one rib that is protruded from the duct may be provided in a cavity between the duct and the sound-absorbing material.

According to another aspect of the present invention, there is provided a ventilator including: a cabinet; a suction blower that is provided in the cabinet to suck outdoor air to the inside of a room through a suction duct; an exhaust blower that is provided in the cabinet to exhaust indoor air to the outside of the room through an exhaust duct; and a heat exchanger that is provided in the cabinet to exchange heat between gas that is exhausted from the inside to the outside of the room and air that is sucked from the outside to the inside of the room, wherein the suction duct forms a blow path having at least one bent part and a sound-absorbing material is provided in the bent part of the blow path of the suction duct.

An indoor exhaust hole for sucking indoor air and an indoor suction hole for exhausting outdoor air to the inside of a room may be formed in one of two opposing surfaces of the cabinet and an outdoor exhaust hole for exhausting the sucked indoor air to the outside of the room and an outdoor suction hole for sucking outdoor air to the inside of the room are formed in the other surface.

At least one of the suction blower and the exhaust blower may be a centrifugal type.

The suction duct may be made of expandable polystyrene (EPS).

In the sound-absorbing material, at least a portion corresponding to a corner of a bent part of the blow path of the duct may be formed in a curve shape.

The sound-absorbing material may be provided to form a cavity between the duct and the sound-absorbing material.

The sound-absorbing material may be provided to form a cavity between the duct and the sound-absorbing material and at least one rib that is protruded from the duct may be provided in a cavity between the duct and the sound-absorbing material.

According to still another aspect of the present invention, there is provided a ventilator including: a cabinet in which an indoor exhaust hole and an indoor suction hole are formed in one surface and an outdoor exhaust hole to be opposite to the indoor exhaust hole is formed and an outdoor suction hole to be opposite to an indoor suction hole is formed in the opposing other surface; a heat exchanger that is provided in the center of the inside of the cabinet to exchange heat between air that is exhausted from the inside to the outside of a room and air that is sucked from the outside to the inside of the room; a suction blower that is provided in one surface of the cabinet about the heat exchanger to generate a suction flow toward the indoor suction hole from the outdoor suction hole; a exhaust blower that is provided in the other surface of the cabinet about the heat exchanger to generate an exhaust flow toward the outdoor exhaust hole from the indoor exhaust hole; an exhaust duct for connecting the exhaust blower and the indoor exhaust hole; and a suction duct for connecting the suction blower and the outdoor suction hole; wherein at least the suction duct among the suction duct and the exhaust duct has at least one bent part and a sound-absorbing material is provided in a bent part in the suction duct or a bent part in the exhaust duct.

The suction blower may be a centrifugal type that sucks air in approximately a parallel direction to an air flow direction of the indoor suction hole and that exhausts air in approximately an orthogonal direction to the air flow direction of the indoor suction hole.

The sound-absorbing material may be provided to form a cavity between the duct and the sound-absorbing material.

The sound-absorbing material may be provided to form a cavity between the duct and the sound-absorbing material and at least one rib that is protruded from the duct may be provided in a cavity between the duct and the sound-absorbing material.

According to a ventilator of the present invention having the above-mentioned construction, in a case where a duct for guiding the suction or exhaust flow has at least one bent part, flow noise is serious due to flow collision in the bent part of the duct. However, because a sound-absorbing material is provided in the bent part of the duct, flow noise that is propagated from the duct can be remarkably reduced.

### BRIEF DESCRIPTION OF THE DRAWINGS

The invention will be described in detail with reference to the following drawings in which like numerals refer to like elements.

FIG. 1 is an exploded perspective view of a ventilator according to an embodiment of the present invention;

FIG. 2 is a front view of a sound absorption structure of the ventilator according to an embodiment of the present invention;

FIG. 3 is a perspective view of a sound absorption structure of the ventilator according to an embodiment of the present invention;

FIG. 4 is an exploded perspective view of a sound absorption structure of the ventilator according to an embodiment of the present invention;

FIG. 5 is a cross-sectional view of the sound absorption structure taken along line A-A of FIG. 3; and

FIG. 6 is a cross-sectional view of a sound absorption structure of a ventilator according to another embodiment of the present invention.

### DETAILED DESCRIPTION OF PREFERRED EMBODIMENTS

Hereinafter, exemplary embodiments of a ventilator according to the present invention will be described in detail with reference to the accompanying drawings.

As those skilled in the art would realize, the described embodiments may be modified in various different ways, all without departing from the spirit or scope of the present invention. Now, the most preferred embodiment will be described.

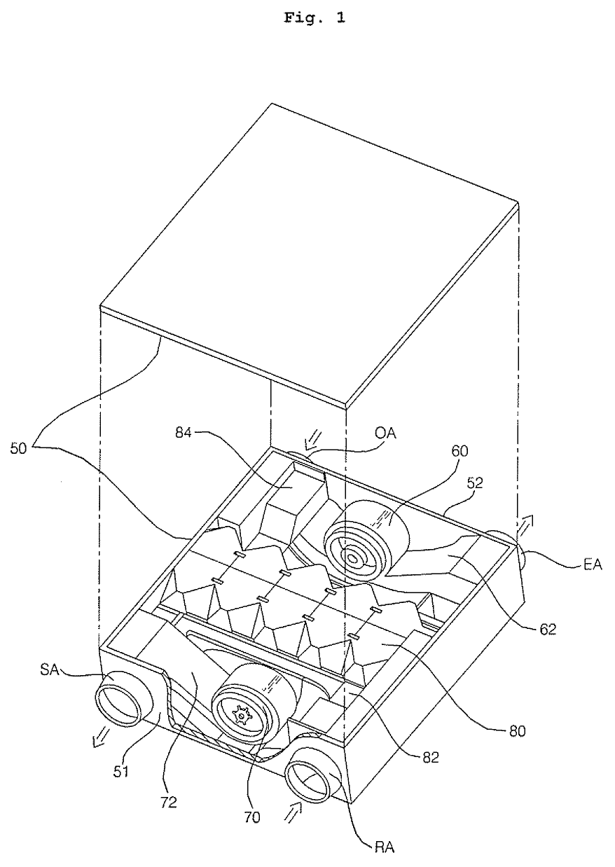

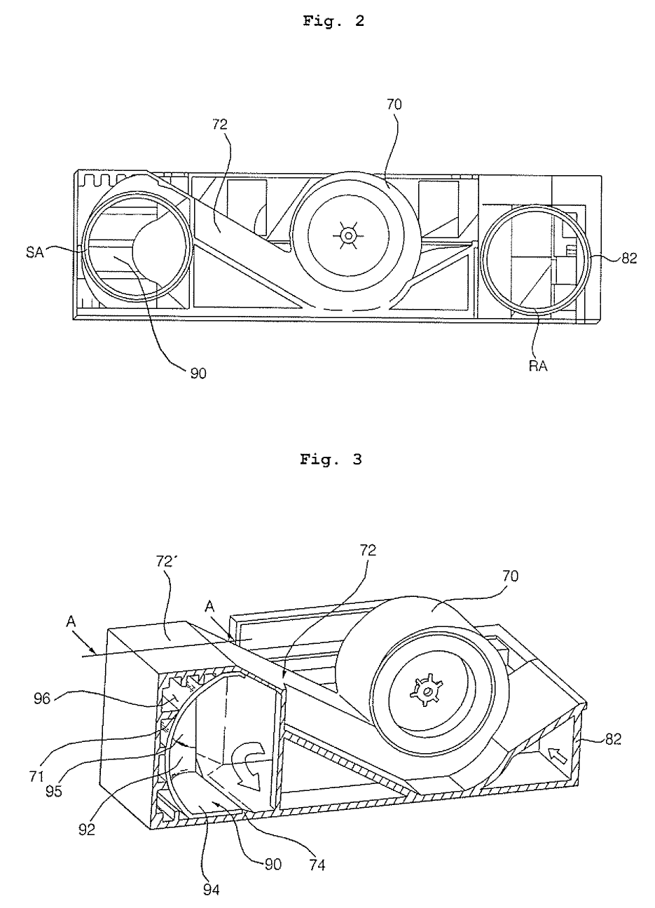

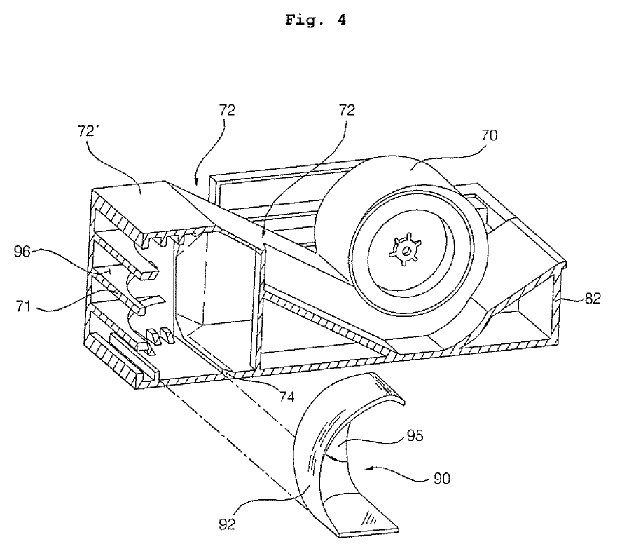

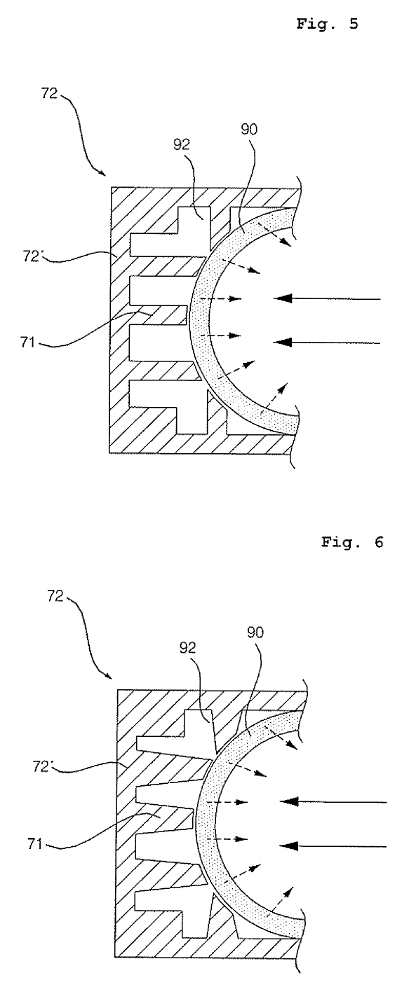

FIG. 1 is an exploded perspective view of a ventilator according to an embodiment of the present invention. FIG. 2 is a front view of a sound absorption structure of the ventilator according to an embodiment of the present invention. FIG. 3 is a perspective view of a sound absorption structure of the ventilator according to an embodiment of the present invention. FIG. 4 is an exploded perspective view of a sound absorption structure of the ventilator according to an embodiment of the present invention. FIG. 5 is a cross-sectional view of the sound absorption structure taken along line A-A of FIG. 3.

The ventilator according to the present invention includes a cabinet 50 that forms an outer appearance, an exhaust blower 60 that is provided within the cabinet 50 to form an exhaust flow so as to exhaust indoor air to the outside of a room, a suction blower 70 that is provided within the cabinet 50 to form a suction flow so as to suck outdoor fresh air to the inside of the room, a heat exchanger 80 that is provided within the cabinet 50 to exchange heat between gas that is exhausted from the inside to the outside of the room and air that is sucked from the outside to the inside of the room.

The cabinet 50 is provided with at least one of each of an indoor exhaust hole PA that sucks indoor air into the cabinet 50 so as to exhaust indoor air to the outside of the room, an outdoor exhaust hole EA that exhausts indoor air that is sucked into the cabinet 50 to the outside of the room, an outdoor suction hole OA that sucks outdoor air into the cabinet 50 so as to suck outdoor air to the inside of the room, and an indoor suction hole SA that exhausts outdoor air that is sucked into the cabinet 50 to the inside of the room.

The indoor exhaust hole RA is formed in one surface 51 of several surfaces of the cabinet 50.

The indoor suction hole SA may be formed in the surface 51 in which the indoor exhaust hole RA is formed among several surfaces of the cabinet 50. Now, for better comprehension and ease of description, a surface in which the indoor exhaust hole RA and the indoor suction hole SA are formed among several surfaces of the cabinet 50 is called an indoor side surface 51.

The outdoor suction hole OA may be formed in a surface 52 in which the indoor exhaust hole RA and the indoor suction hole SA are not formed among several surfaces of the cabinet 50. Particularly, the outdoor suction hole OA may be formed in a surface that is opposite to the surface in which the indoor exhaust hole RA and the indoor suction hole SA are formed among several surfaces of the cabinet 50.

The outdoor exhaust hole ERA may be formed in a surface 52 in which the outdoor suction hole OA is formed among several surfaces of the cabinet 50. Now, for better comprehension and ease of description, a surface in which the outdoor suction hole OA and the outdoor exhaust hole EA are formed among several surfaces of the cabinet 50 is called an outdoor side surface 52.

The indoor exhaust hole RA and the outdoor exhaust hole EA may be positioned to be opposite to each other in a direction in which the indoor side surface 51 and the outdoor side surface 52 of the cabinet 50 are disposed apart from each other. Furthermore, the indoor suction hole SA and the outdoor suction hole OA may be positioned to be opposite to each other in a direction in which the indoor side surface 51 and the outdoor side surface 52 of the cabinet 50 are disposed apart from each other.

The exhaust blower 60 is positioned in the outdoor side surface 52 of the cabinet 50 about the heat exchanger 80.

The exhaust blower 60 may be positioned in the center in a direction in which the outdoor exhaust hole EA and the outdoor suction hole OA are disposed apart from each other.

The exhaust blower 60 includes an exhaust fan that rotates with a driving force of an exhaust motor. The exhaust fan may be a centrifugal type that sucks air in its axial direction and exhausts air in its centrifugal direction.

Therefore, the exhaust blower 60 may suck air in approximately a parallel direction to an air flow direction of the outdoor exhaust hole EA, that is, in a direction in which the indoor side surface 51 and the outdoor side surface 52 of the cabinet 50 are disposed apart from each other and exhaust air in an orthogonal direction to an air flow direction of the outdoor exhaust hole EA.

The exhaust blower 60 is positioned at the opposite side of the heat exchanger 80 so that a suction port for sucking air to the inside thereof communicates with the heat exchanger 80.

In the exhaust blower 60, an exhaust port for exhausting air therein is positioned in the outdoor exhaust hole EA side between the outdoor exhaust hole EA and the outdoor suction hole OA about the exhaust blower 60.

The exhaust port of the exhaust blower 60 and the outdoor exhaust hole EA are connected to each other through an exhaust duct 62 that forms a blow path so as to guide an exhaust flow by blowing power of the exhaust blower 60.

The exhaust duct 62 has at least one bent structure because a flow direction of air that is exhausted from the exhaust blower 60 is orthogonal to an air flow direction of the outdoor exhaust hole EA. At this time, it is preferable that the exhaust duct 62 has a structure that is bent with approximately a right angle.

The suction blower 70 is positioned in the indoor side surface 51 of the cabinet 50 about the heat exchanger 80.

The suction blower 70 may be positioned in the center in a direction in which the indoor exhaust hole RA and the indoor suction hole SA are disposed apart from each other.

The suction blower 70 includes a suction fan that rotates with a driving force of a suction motor. The suction fan may be a centrifugal type that sucks air in its axial direction and exhausts air in its centrifugal direction.

Therefore, the suction blower 70 may suck air in approximately a parallel direction to an air flow direction of the indoor suction hole SA, that is, in a direction in which the indoor side surface 51 and the outdoor side surface 52 of the cabinet 50 are disposed apart from each other and exhaust air in approximately an orthogonal direction to an air flow direction of the indoor suction hole SA.

The suction blower 70 is positioned at the opposite side of the heat exchanger 80 so that a suction port for sucking air to the inside thereof communicates with the heat exchanger 80.

In the suction blower 70, an exhaust port for exhausting air therein is positioned in the indoor suction hole SA side between the indoor exhaust hole RA and the indoor suction hole SA about the suction blower 70.

The exhaust port of the suction blower 70 and the indoor suction hole SA are connected to each other through a suction duct 72 that forms a blow path so as to guide a suction flow by blowing power of the suction blower 70.

A blow path of the suction duct 72 has at least one bent structure because a flow direction of air that is exhausted from the suction blower 70 is orthogonal to an air flow direction of the indoor suction hole SA. It is preferable that a blow path of the suction duct 72 has a structure that is bent with approximately a right angle. At this time, the suction duct 72 may have a structure in which only a blow path thereof has a bent part or a structure in which both of the blow path of the suction duct 72 and an outer appearance thereof have a bent part.

Now, for better comprehension and ease of description, in the present enforcement, it will be described by limiting to a structure in which both of the blow path of the suction duct 72 and the outer appearance thereof have a bent part.

The heat exchanger 80 is positioned in the center in a direction in which the indoor side surface 51 and the outdoor side surface 52 of the cabinet 50 are disposed apart from each other.

The heat exchanger 80 includes a heat exchange element for performing heat exchange between suction air and exhaust air. The heat exchange element may be formed in a hexagonal shape, a counter flow type, or a parallel flow type.

The heat exchanger 80 may be provided with a free filter for filtering a foreign substance in each of a side that sucks the flow by the exhaust blower 60 and a side that sucks the flow by the suction blower 70. The heat exchange element and a front and rear free filters of the heat exchanger 80 may be checked through a checking device that is detachably provided in the cabinet 50.

The cabinet 50 may be further provided with a first heat exchanger duct 82 that guides the flow that is generated by the exhaust blower 60 and passes through the indoor exhaust hole RA to the heat exchanger 80 and a second heat exchanger duct 84 that guides the flow that is generated by the suction blower 70 and passes through the outdoor suction hole OA to the heat exchanger 80.

The ventilator according to the present invention has a sound absorption structure for minimizing flow noise due to at least the suction flow by the suction blower 70 among both of the exhaust flow by the exhaust blower 60 and the suction flow by the suction blower 70 because flow noise due to the suction flow that is generated by the suction blower 70 is directly propagated to the inside of the room.

The sound absorption structure includes a sound-absorbing material 90 that can absorb the flow noise.

When the suction flow by the suction blower 70 passes through a bent part of the blow path of the suction duct 72, the suction flow is collided to the suction duct 72 or the suction flows are collided to each other due to rapid change of a suction flow direction by the suction blower 70, whereby flow noise increases due to flow resistance. Accordingly, the sound-absorbing material 90 is positioned in a bent part of a blow path thereof within the suction duct 72.

In order to minimize suction flow resistance by guiding the suction flow by the suction blower 70 in a streamline direction, it is preferable that the sound-absorbing material 90 is formed in a curve shape so that at least a portion 92 corresponding to the corner of the bent part of the blow path of the suction duct 72 forms a curve part.

Parts 94 and 95 of the sound-absorbing material 90 may come in contact with an inner wall of the suction duct 72 so that the sound-absorbing material 90 may be securely fixed to the inside of the suction duct 72.

The sound-absorbing material 90 may be securely fixed to the inside of the suction duct 72 by a stopper rib 74 that is protruded from the suction duct 72.

Furthermore, the sound absorption structure may further include a cavity 96, which is a sound-absorbing space that is positioned between the sound-absorbing material 90 and the inner wall of the suction duct 72 to absorb flow noise passing through the sound-absorbing material 90.

At least one rib 71 that is protruded toward the sound-absorbing material 90 from the suction duct 72 to support the sound-absorbing material 90 may be provided in the cavity 96 between the sound-absorbing material 90 and the inner wall of the suction duct 72.

The rib 71 securely supports the sound-absorbing material 90, but it is preferable that a plurality of ribs 71 is provided so as to effectively absorb flow noise in the cavity 96 between the sound-absorbing material 90 and the inner wall of the suction duct 72, and the ribs may have a predetermined shape.

The ribs 71 may have a quadrangular section so that the rib 71 may be protruded in a uniform thickness toward the sound-absorbing material 90 from the inner wall of the suction duct 72.

Alternatively, as shown in FIG. 6, the ribs 71 may have a trapezoidal section or a triangular section that has a gradually thinner thickness as the ribs 71 go toward the sound-absorbing material 90 from the inner wall of the suction duct 72.

Furthermore, the sound absorption structure may have a soundproofing function and a heat-insulating function as at least the suction duct 72 among the exhaust duct 62 and the suction duct 72 is made of expandable polystyrene (EPS).

A function and an effect of the ventilator according to the present invention having the above-described configuration are as follows.

If the exhaust blower 60 is driven, an exhaust process is performed by blowing power thereof as follows.

That is, after indoor air is sucked into the cabinet 50 through the indoor exhaust hole RA of the cabinet 50 with the blowing power of the exhaust blower 60, the air is sucked into the exhaust blower 60 via the heat exchanger 80 and then the air is guided to the outdoor exhaust hole EA of the cabinet 50 by the duct 62 of the exhaust blower 60 to exhaust to the outside of the room.

Furthermore, the suction blower 70 along with the exhaust blower 60 is driven, and an suction process is performed by blowing power of the suction blower 70 as follows.

After outdoor air is sucked into the cabinet 50 through the outdoor suction hole OA of the cabinet 50 with the blowing power of the suction blower 70, the air is sucked into the suction blower 70 via the heat exchanger 80 and then the air is guided to the indoor suction hole SA of the cabinet 50 through the suction duct 72 to suck to the inside of the room.

At this time, as described above, because a sound absorption structure is provided in the suction duct 72, noise of the suction flow passing through the suction duct 72 can be remarkably reduced.

That is, when the suction flow within the suction duct 72 passes through the bent part of the blow path of the suction duct 72, noise of the suction flow within the suction duct 72 is absorbed and reduced by the sound-absorbing material 90.

Furthermore, as flow noise that is reduced once by the sound-absorbing material 90 is absorbed into a cavity 96 between the sound-absorbing material 90 and the suction duct 72, the noise can be remarkably absorbed by a reflection phenomenon and an interference phenomenon.

Furthermore, when the suction flow within the suction duct 72 passes through the bent part in the blow path of the suction duct 72, the flow may be flowed in a streamline direction by a curved part 94 of the sound-absorbing material 90. Accordingly, as flow collision or flow resistance thereof is minimized, flow noise thereof can be remarkably reduced than the existent one.

Furthermore, as the suction duct 72 is made of expandable polystyrene, noise of the suction flow passing through the suction duct 72 can be absorbed by a soundproofing effect of expandable polystyrene itself.

Therefore, when the ventilator according to the present invention is operated, noise of the suction flow due to the suction blower 70 is hardly felt in the room.

As described above, in the ventilator according to embodiments of the present invention, when the blow path of the duct for guiding the suction flow or the exhaust flow by the blower has a bent part, flow noise increases due to flow collision or flow resistance in the bent part of the blow path of the duct. Accordingly, by providing a sound-absorbing material in the bent part of the blow path of the duct, noise of the flow passing through the duct is absorbed in the sound-absorbing material such that the flow noise can be remarkably reduced than existent noise and thus sensitivity quality thereof improves, compared to that of existent one.

Furthermore, in the ventilator according to the present invention, as the sound-absorbing material is formed in a curve shape so as to guide the flow within the duct in a streamline direction, flow collision or flow resistance is minimized in the bent part of the duct. Accordingly, flow noise can be remarkably reduced than existent noise and thus sensitivity quality thereof can be maximized.

Furthermore, in the ventilator according to the present invention, as a cavity, which is a sound-absorbing space, is formed between the sound-absorbing material and the duct, flow noise can be remarkably reduced than existent noise and thus sensitivity quality thereof can be maximized.

Furthermore, in the ventilator according to the present invention, a sound-absorbing material can be supported by a rib that is protruded from the duct and a cavity between the sound-absorbing material and the duct can by easily formed.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims

What is claimed is:

1. A ventilator comprising:
a blower;
a duct that is connected to the blower to form a blow path having at least one bent part; and
a sound-absorbing material that is provided in the bent part of the blow path of the duct to absorb noise within the blow path thereof.

2. The ventilator of claim 1, wherein the blower comprises an exhaust blower for exhausting indoor air to the outside of a room and a suction blower for sucking outdoor air to the inside of the room.

3. The ventilator of claim 1, wherein the blower comprises an exhaust blower for exhausting indoor air to the outside of a room and a suction blower for sucking outdoor air to the inside of the room; and
the sound-absorbing material is provided in at least a duct that forms a blow path of the suction blower.

4. The ventilator of claim 1, wherein the duct is made of expandable polystyrene (EPS).

5. The ventilator of claim X, wherein in the duct, the blow path thereof has at least one bent part that is bent with a right angle.

6. The ventilator of claim 1, wherein in the sound-absorbing material, at least a portion corresponding to a corner of the bent part of the blow path of the duct is formed in a curve shape.

7. The ventilator of claim 1, wherein the sound-absorbing material is provided to form a cavity (empty space) between the duct and the sound-absorbing material.

8. The ventilator of claim 1, wherein the sound-absorbing material is supported by at least one rib that is protruded from the duct.

9. The ventilator of claim 1, wherein the sound-absorbing material is provided to form a cavity between the duct and the sound-absorbing material and at least one rib that is protruded from the duct is provided in a cavity between the duct and the sound-absorbing material.

10. A ventilator comprising:
a cabinet;
a suction blower that is provided in the cabinet to suck outdoor air to the inside of a room through a suction duct;
an exhaust blower that is provided in the cabinet to exhaust indoor air to the outside of the room through an exhaust duct; and
a heat exchanger that is provided in the cabinet to exchange heat between air that is exhausted from the inside to the outside of the room and air that is sucked from the outside to the inside of the room,
wherein the suction duct forms a blow path having at least one bent part and a sound-absorbing material is provided in the bent part of the blow path of the suction duct.

11. The ventilator of claim 10, wherein an indoor exhaust hole for sucking indoor air and an indoor suction hole for exhausting outdoor air to the inside of a room are formed in one of two opposing surfaces of the cabinet and an outdoor exhaust hole for exhausting the sucked indoor air to the outside of the room and an outdoor suction hole for sucking outdoor air to the inside of the room are formed in the other surface.

12. The ventilator of claim 10, wherein at least one of the suction blower and the exhaust blower is a centrifugal type.

13. The ventilator of claim 10, wherein the suction duct is made of expandable polystyrene (EPS).

14. The ventilator of claim 10, wherein in the sound-absorbing material, at least a portion corresponding to a corner of the bent part of the blow path of the duct is formed in a curve shape.

15. The ventilator of claim 10, wherein the sound-absorbing material is provided to form a cavity between the duct and the sound-absorbing material.

16. The ventilator of claim 10, wherein the sound-absorbing material is provided to form a cavity between the duct and the sound-absorbing material and at least one rib that is protruded from the duct is provided in a cavity between the duct and the sound-absorbing material.

17. A ventilator comprising:
a cabinet in which an indoor exhaust hole and an indoor suction hole are formed in one surface and an outdoor exhaust hole to be opposite to the indoor exhaust hole is formed and an outdoor suction hole to be opposite to the indoor suction hole is formed in the opposing other surface;
a heat exchanger that is provided in the center of the inside of the cabinet to exchange heat between air that is exhausted from the inside to the outside of a room and air that is sucked from the outside to the inside of the room;
a suction blower that is provided in one surface of the cabinet about the heat exchanger to generate a suction flow toward the indoor suction hole from the outdoor suction hole;
a exhaust blower that is provided in the other surface of the cabinet about the heat exchanger to generate an exhaust flow toward the outdoor exhaust hole from the indoor exhaust hole;
an exhaust duct for connecting the exhaust blower and the indoor exhaust hole; and
a suction duct for connecting the suction blower and the outdoor suction hole;
wherein at least the suction duct among the suction duct and the exhaust duct has at least one bent part and a sound-absorbing material is provided in a bent part in the suction duct or a bent part in the exhaust duct.

18. The ventilator of claim 17, wherein the suction blower is a centrifugal type for sucking air in approximately a parallel direction to an air flow direction of the indoor suction hole and for exhausting air in approximately an orthogonal direction to an air flow direction of the indoor suction hole.

19. The ventilator of claim 17, wherein the sound-absorbing material is provided to form a cavity between the duct and the sound-absorbing material.

20. The ventilator of claim 17, wherein the sound-absorbing material is provided to form a cavity between the duct and the sound-absorbing material and at least one rib that is protruded from the duct is provided between the duct and the sound-absorbing material.
